(19) United States
(12) Patent Application Publication
(10) Pub. No.: US 2019/0368407 A1
(43) Pub. Date: Dec. 5, 2019

(54) INTERNAL COMBUSTION ENGINE

(71) Applicant: HONDA MOTOR CO., LTD., Tokyo (JP)

(72) Inventors: Mashu Kurata, Wako-shi, Saitama (JP); Yoshikazu Yamada, Wako-shi, Saitama (JP)

(21) Appl. No.: 16/478,186

(22) PCT Filed: Dec. 12, 2017
(86) PCT No.: PCT/JP2017/044564

§ 371 Date: Jul. 16, 2019

(30) Foreign Application Priority Data
Jan. 18, 2017 (JP) 2017-006871

(51) Int. Cl. F01P 3/22; F01P 9/04; F01P 3/04; F01P 11/10; F01P 11/04; F02F 1/06; F02F 1/16; F01P 5/04; F01P 3/18; F01P 5/06

(52) U.S. Cl. CPC F01P 3/22; F01P 9/04; F01P 3/04; F01P 11/10; F01P 11/04; F01P 2001/005; F02F 1/16; F01P 5/04; F01P 3/18; F01P 5/06; F02F 1/06

(57) ABSTRACT

An internal combustion engine that can ensure an adequate cooling performance by using a small number of component parts, and can be minimized in size. The cooling device includes a boiling water cooling device including a water jacket, coolant piping, steam piping and a radiator, an air cooling fan connected to one end of a crankshaft projecting from an outer surface of the engine main body, and a cover member provided on the engine main body so as to cover the air cooling fan, and define a cooling air passage extending to a radiator core.

### TECHNICAL FIELD

The present invention relates to an internal combustion engine provided with a cooling device, and more particularly to an internal combustion engine provided with a cooling device including a radiator for boiling cooling and an air cooling fan.

### BACKGROUND OF THE INVENTION

An internal combustion engine is typically provided with an air cooled or a water cooled cooling device. In the case of a CAI (controlled auto-ignition) engine based on the controlled auto-ignition combustion, the engine coolant is required to be raised to an appropriate temperature as quickly as possible at the startup, and the engine temperature is required to be prevented from becoming excessively high so that stable combustion may be maintained. Also, in the case of a general-purpose engine, the size of the engine is desired to be minimized. Based on such considerations, the applicants of the present application previously proposed a boiling cooling device in which the lower parts of a water jacket and a radiator of an internal combustion engine are communicated with each other via coolant piping, an upper part of the water jacket is communicated with the radiator via steam piping, and a substantially large part of the radiator is located above the upper end of the water jacket (see Patent Document 1). In this boiling cooling device, the state of combustion can be stabilized in a short period of time, and the coolant can be naturally circulated between the radiator and the water jacket without requiring a coolant pump, thereby minimizing the number of component parts and the size of the cooling device.

### PRIOR ART DOCUMENT(S)

### Patent Document(s)

Patent Document 1: JP2016-160907A

### SUMMARY OF THE INVENTION

### Task to be Accomplished by the Invention

However, the boiling cooling device disclosed in Patent Document 1 requires a substantially large part of the radiator to be located above the upper end of the water jacket so that the size of the internal combustion engine including the radiator tends to be undesirable great particularly when the radiator is increased in size to ensure an adequate cooling performance. The heat exchange efficiency may be improved by adding an electric cooling fan to the radiator, but this causes the size of the internal combustion engine to be increased, and an electric motor for driving the electric cooling fan is required.

In view of such problems of the prior art, a primary object of the present invention is to provide an internal combustion engine which can ensure an adequate cooling performance by using a small number of component parts, and can be minimized in size.

### Means to Accomplish the Task

To achieve such an object, the present invention provides an internal combustion engine (E) comprising an engine main body (1) defining a water jacket (61) therein, and a cooling device (60) for cooling a coolant (W) in the waterjacket, the cooling device comprising: a radiator (64) provided such that a large part of the radiator is located above an upper end of the water jacket; steam piping (63) communicating an upper part of the water jacket with the radiator to forward the coolant that has boiled in the water jacket to the radiator; coolant piping (62) communicating a lower part of the radiator with a lower part of the water jacket to forward the coolant that has been cooled in the radiator to the water jacket; an air cooling fan (70) connected to one end of a crankshaft (8) projecting from an outer surface of the engine main body; and a cover member (72) provided on the engine main body so as to cover the air cooling fan, and define a cooling air passage (75) extending to a heat emitting part (64B) of the radiator.

According to this arrangement, since the air cooling fan is driven by the crankshaft, no electric motor is required. Also, since the cover member defines a cooling air passage extending to a heat emitting part of the radiator, and cooling air is forwarded to the radiator by the cooling fan, the heat exchange efficiency of the radiator is improved so as to permit the size of the radiator to be minimized. Furthermore, in addition to the air cooling of the engine, the cooling device employs the boiling cooling of the engine that combines the forced air cooling of the radiator so that the necessary size of the radiator can be minimized.

In the above arrangement, preferably, the air cooling fan (70) is a centrifugal fan, and the cover member (72) includes a duct (76) extending from the centrifugal fan in a tangential direction to the radiator (64).

According to this arrangement, since the duct is provided on an outer periphery of the cover member, the size of the internal combustion engine as measure in the direction of the rotational axial line of the crankshaft can be minimized.

In the above arrangement, preferably, the engine main body (1) is disposed such that a rotational axis of the crankshaft (8) extends laterally and a cylinder axial line (A) extends in a substantially fore and aft direction, and the radiator (64) is disposed such that the upper end thereof leans toward a side of the one end (left end) of the crankshaft, and a lower end of the radiator is located higher than the upper end of the water jacket (61).

According to this arrangement, the size of the internal combustion engine as measured in the vertical direction can be minimized.

In the above arrangement, preferably, the duct (76) extends toward a downwardly facing sloped surface (64D) of the heat emitting part (64B) of the radiator (64).

According to this arrangement, the duct may extend linearly and may be short in length so that the size of the internal combustion engine can be minimized.

In the above arrangement, preferably, the steam piping (63) communicates with a lower part (64C) of the radiator (64).

According to this arrangement, the steam piping can be minimized in length so that the size of the internal combustion engine can be minimized.

In the above arrangement, preferably, an outer surface of the engine main body (1) is provided with a plurality of fins (3A, 4A), and the cover member (72) defines a cooling air inlet (72A) on a side of the fins.

According to this arrangement, the engine main body can be efficiently cooled by the air cooling fan, and this in turn allows the size of the radiator to be minimized while ensuring a required cooling performance.

### Effect of the Invention

According to the above structure, it is possible to provide an internal combustion engine which can ensure an adequate cooling performance by using a small number of component parts, and can be minimized in size.

### BRIEF DESCRIPTION OF THE DRAWINGS

FIG. 1 is a vertical sectional view of an internal combustion engine provided with a cooling device according to an embodiment of the present invention;

FIG. 2 is a horizontal sectional view of the internal combustion engine taken along line II-II of FIG. 1;

FIG. 3 is a front view showing the internal combustion engine of the present embodiment partly in section;

FIG. 4 is a left side view of the internal combustion engine of the present embodiment; and

FIG. 5 is a schematic sectional view of the cooling device of the present embodiment.

### MODES FOR CARRYING OUT THE INVENTION

An embodiment of the present invention as applied to a single-cylinder uniflow two-stroke engine (hereinafter, referred to as engine E) is described in the following with reference to the appended drawings. In the present embodiment, the engine E is used as a drive source of a generator.

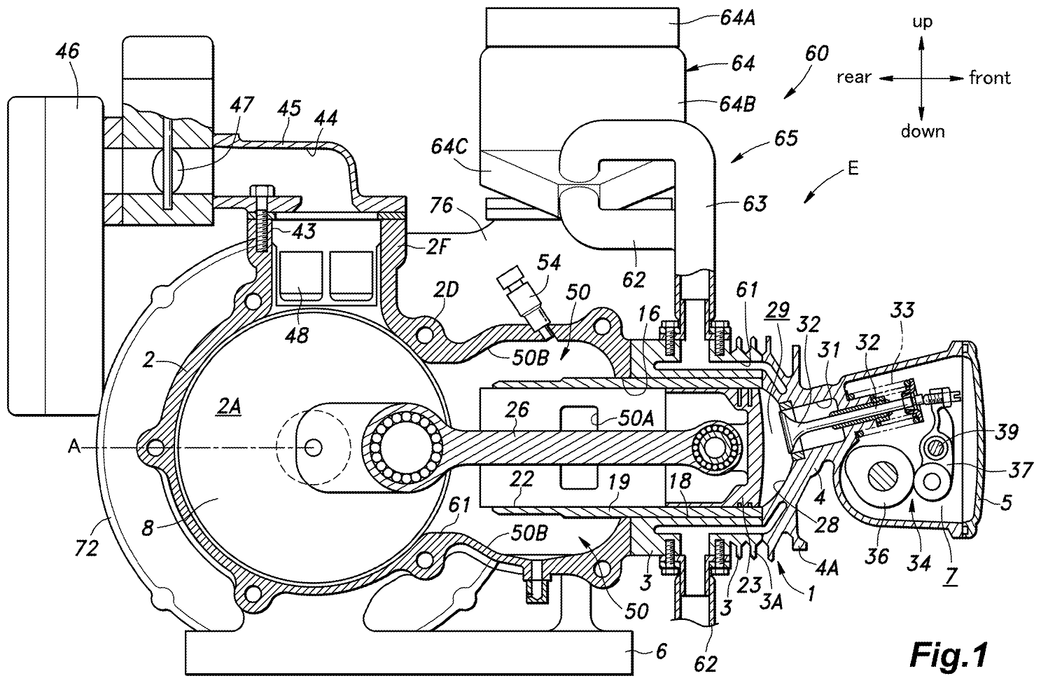

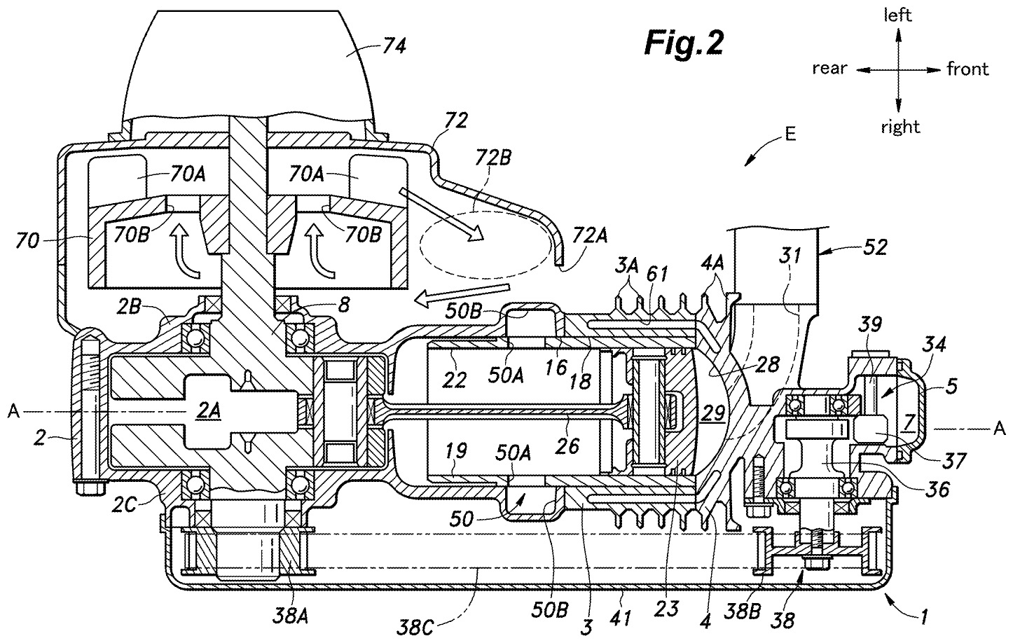

As shown in FIGS. 1 and 2, the engine main body 1 of the engine E includes a crankcase 2 defining a crank chamber 2A therein, a cylinder block 3 connected to the front end of the crankcase 2, a cylinder head 4 connected to the front end of the cylinder block 3, and a head cover 5 connected to the front end of the cylinder head 4 to define a valve actuation chamber 7 in cooperation with the cylinder head 4. The engine main body 1 extends in a fore and aft direction, and the cylinder axis A is disposed substantially horizontally in the fore and aft direction. A base member 6 (FIG. 1) for maintaining the engine main body 1 in a prescribed posture is connected to a lower outer surface part of the crankcase 2.

The crankcase 2 consists of a pair of crankcase halves that are laterally divided from each other about a plane extending vertically (and passing through the cylinder axial line A). The two crankcase halves are fastened together by using threaded bolts to define a crank chamber 2A between the two halves. A crankshaft 8 is rotatably supported by a left side wall 2B and a right side wall 2C of the crankcase 2 via bearings.

The crankshaft 8 includes a pair of journals supported by the side walls 2B and 2C (FIG. 2) of the crankcase 2, respectively, a pair of webs provided between the journals, and a crank pin supported by the webs at a position eccentric to the journals. The rotational axis of the crankshaft 8 extends substantially horizontally in the lateral direction.

The left end of the crankshaft 8 is passed through the left side wall 2B of the crankcase 2 to protrude leftward, and the right end of the crankshaft 8 is passed through the right side wall 2C of the crankcase 2 to protrude rightward. A seal member for ensuring the airtightness of the crank chamber 2A is provided in the parts where the left end of the crankshaft 8 is passed through the left side wall 2B, and the right end of the crankshaft 8 is passed through the right side wall 2C.

A front end of the crankcase 2 is formed with a first sleeve receiving hole 16 having a circular cross section, extending in the fore and aft direction and having a front end opening at the front end face of the crankcase 2 and a rear end opening toward the crank chamber 2A.

The cylinder block 3 extends in the fore and aft direction, and is fastened to the front end face of the crankcase 2 at the rear end face thereof. The cylinder block 3 is formed with a second sleeve receiving hole 18 passed through from the front end face to the rear end face thereof in the fore and aft direction. The rear end opening of the second sleeve receiving hole 18 coaxially opposes the front end opening of the first sleeve receiving hole 16 of the cylinder block 3, and are connected to each other. The inner diameters of the first sleeve receiving hole 16 and the second sleeve receiving hole 18 are equal to each other to define a continuous hole.

A cylindrical cylinder sleeve 19 is press fitted into the first sleeve receiving hole 16 and the second sleeve receiving hole 18. The rear end of the cylinder sleeve 19 protrudes rearward from the rear end opening of the first sleeve receiving hole 16 so as to form a protruding end inside the crank chamber 2A. The front end of the cylinder sleeve 19 is disposed at a position flush with the front end face of the cylinder block 3, and abuts on the rear end face of the cylinder head 4 coupled to the cylinder block 3. The inner bore of the cylinder sleeve 19 forms a cylinder 22.

A piston 23 is received in the cylinder 22 so as to be capable of reciprocating. The piston 23 is provided with a piston pin extending parallel to the crankshaft 8, and the piston pin rotatably supports a small end of a connecting rod 26.

A big end of the connecting rod 26 is rotatably supported by the crank pin via a bearing. The reciprocating movement of the piston 23 is converted into the rotational movement of the crankshaft 8 by the connecting rod 26 connecting the piston 23 and the crankshaft 8 to each other.

A part of the rear end surface of the cylinder head 4 corresponding to the cylinder sleeve 19 defines a hemispherical combustion chamber recess 28. A front part of the cylinder 22 defines a combustion chamber 29 in cooperation with the combustion chamber recess 28 and the top surface of the piston 23.

The cylinder head 4 is provided with a spark plug (not shown in the drawings) so as to face the combustion chamber 29. Further, the cylinder head 4 is provided with an exhaust port 31 opening at the top of the combustion chamber 29, and a poppet type exhaust valve 32 (FIG. 1) configured to open and close the exhaust port 31. The stem end of the exhaust valve 32 is disposed in the valve actuation chamber 7, and is biased in the closing direction by a valve spring 33 (FIG. 1). The exhaust valve 32 is opened and closed by a valve actuation mechanism 34 in synchronization with the rotation of the crankshaft 8.

The valve actuation mechanism 34 includes a camshaft 36 and a rocker arm 37. The camshaft 36 is rotatably supported by the cylinder head 4 in parallel with the crankshaft 8, and the right end thereof projects out of the cylinder head 4.

The camshaft 36 is connected to the crankshaft 8 by a transmission mechanism 38 (FIG. 2). As shown in FIG. 2, the transmission mechanism 38 includes a crank pulley 38A attached to the right end of the crankshaft 8, a cam pulley 38B attached to the right end of the camshaft 36, and a timing belt 38C passed around the crank pulley 38A and the cam pulley 38B. The transmission mechanism 38 causes the camshaft 36 to rotate at the same angular speed as the crankshaft 8.

A seal member for ensuring the air tightness of the valve actuation chamber 7 is provided in a part of the cylinder head 4 where the camshaft 36 extends through so that the valve actuation chamber 7 is sealed. The valve actuation chamber 7 stores lubricating oil. The lubricating oil stored in the valve actuation chamber 7 is entrained by the camshaft 36 to lubricate various sliding parts such as the camshaft 36 and the rocker arm 37.

As shown in FIG. 1, the rocker arm 37 is rotatably supported by a rocker shaft 39 supported by the cylinder head 4. The rocker shaft 39 extends in parallel with the camshaft 36. The rocker arm 37 is in contact with the stem end of the exhaust valve 32 at one end so that as the rocker arm 37 rotates by being pushed by the camshaft 36, the rocker arm 37 pushes the exhaust valve 32 in the opening direction against the biasing force of the valve spring 33. The exhaust valve 32 is opened once during each revolution of the crankshaft 8.

As shown in FIG. 2, an end plate 41 is attached to the right side surface of the crankcase 2, the cylinder block 3, and the cylinder head 4. The end plate 41 is fastened to the outer surface of the crankcase 2, the cylinder block 3, and the cylinder head 4 at the peripheral edge thereof so as to cover the transmission mechanism 38.

As shown in FIG. 1, the upper wall 2D of the crankcase 2 is formed with an upwardly protruding portion 2F. The interior of the protruding portion 2F defines an intake port 43 extending vertically, and the intake port 43 communicates with the crank chamber 2A at the lower end thereof, and opens to the outside at the upper end thereof. The outer end of the intake port 43 is connected to a downstream end of an intake pipe 45 forming an intake passage 44. The intake passage 44 includes an air inlet, an air cleaner 46 and a throttle valve 47 in that order from the upstream end thereof. An intake valve 48 is interposed between the intake port 43 and the intake passage 44.

The intake valve 48 is a one-way valve that allows the fluid flow from the side of the intake passage 44 to the side of the intake port 43 (crank chamber 2A), but blocks the fluid flow from the side of the intake port 43 (crank chamber 2A) to the side of the intake port 43. The intake valve 48 is a reed valve that includes a gable-shaped base protruding toward the crank chamber 2A, a through hole passed through the base, and a flexible reed member that covers the end of the through hole on the side of the crank chamber 2A. The intake valve 48 is normally closed, and when the pressure in the crank chamber 2A decreases to a level lower than the pressure in the intake passage 44 by a prescribed value owing to the upward movement the piston 23, the reed member bends so as to open the intake valve 48.

As shown in FIGS. 1 and 2, the crankcase 2 and the cylinder sleeve 19 are provided with a scavenging passage 50 communicating the crank chamber 2A with the interior of the cylinder sleeve 19. The scavenging passage 50 includes a pair of scavenging ports 50A formed in the cylinder sleeve 19 and a passage portion 50B extending from the scavenging ports 50A to the crank chamber 2A. The passage portion 50B is formed in front of the crankcase 2 and around the first sleeve receiving hole 16. In the present embodiment, the passage portion 50B includes a pair of linear sections extending forward in an upper part and a lower part of the cylinder sleeve 19, respectively, and an annular section extending annularly along the outer periphery of the cylinder sleeve 19, and connected to the front ends of the two linear sections. The passage portion 50B communicates with the scavenging ports 50A at the annular section thereof. In the present embodiment, the scavenging ports 50A are formed on the left and right sides of the cylinder sleeve 19. The fore and aft length of each scavenging port 50A is set smaller than the fore and aft length of the outer circumferential surface of the piston 23.

The scavenging ports 50A (scavenging passage 50) are opened and closed by the reciprocating motion of the piston 23. More specifically, when the piston 23 is in the position corresponding to the scavenging ports 50A, the scavenging passage 50 is closed by the outer circumferential surface of the piston 23. When the trailing edge (rear edge) of the piston 23 is in front of the trailing edge of the scavenging ports 50A (on the side of the top dead center), the scavenging passage 50 is opened so as to communicate the scavenging passage 50 to a part of the cylinder 22 located behind the piston 23 (crank chamber 2A). When the leading edge (front edge) of the piston 23 is behind the leading edge of the scavenging ports 50A (on the side of the bottom dead center), the scavenging passage 50 is opened so as to communicate the scavenging passage 50 to a part of the cylinder 22 located ahead of the piston 23 (combustion chamber 29).

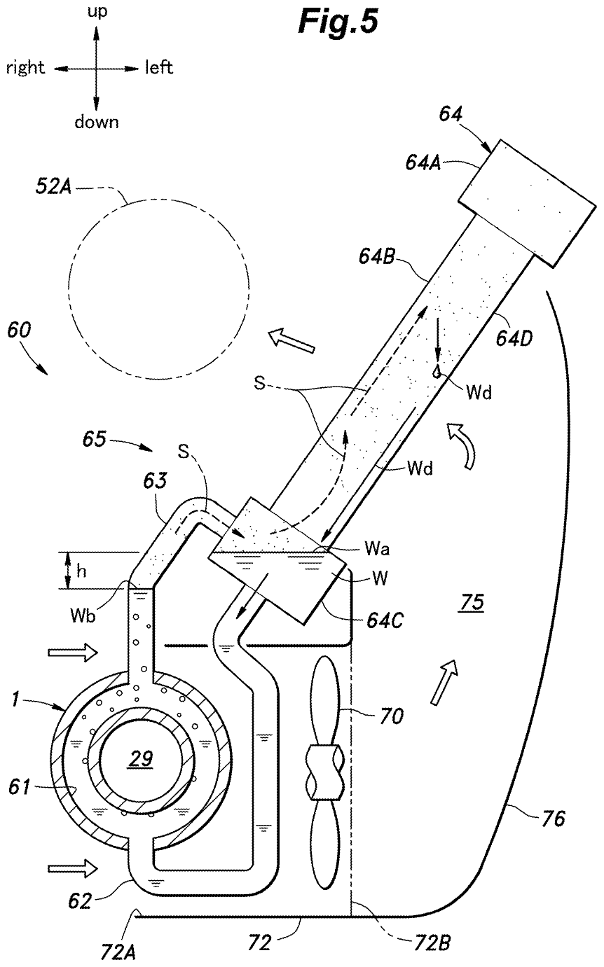

As shown in FIG. 2, the left side of the cylinder head 4 is connected to an exhaust device 52 connected to the exhaust port 31. The exhaust device 52 internally defines an exhaust passage of a certain length, and is provided with a muffler 52A (FIG. 5) at the downstream end thereof. As shown in FIG. 5, the muffler 52A is disposed above the crankcase 2 and the cylinder block 3.

As shown in FIG. 1, a fuel injection valve 54 is attached to the upper wall 2D of the crankcase 2. The tip of the fuel injection valve 54 is directed to the passage portion 50B of the scavenging passage 50, and is configured to inject fuel toward the passage portion 50B. More preferably, the fuel injection valve 54 is injected at a position as close to the scavenging ports 50A of the scavenging passage 50 as possible. The fuel injection valve 54 injects fuel into the crank chamber 2A at a predetermined timing.

The engine E configured in this way operates after startup as follows. First of all, in an upward stroke of the piston 23, the scavenging passage 50 is closed as the piston 23 ascends (advances). Further, the expansion of the crank chamber 2A accompanying the forward movement of the piston 23 lowers the pressure in the crank chamber 2A. As a result, the intake valve 48 opens so that fresh air flows into the crank chamber 2A via the intake port 43. At the same time, the mixture in the front part (combustion chamber 29) of the cylinder 22 is compressed by the piston 23. When the piston 23 is near the top dead center, ignition of the mixture takes place by a spark plug or self-ignition, and the combustion of fuel is initiated.

Thereafter, as the piston 23 starts moving downward, the pressure in the crank chamber 2A rises due to the contraction of the crank chamber 2A accompanying the downward movement (retraction) of the piston 23. As a result, the intake valve 48 is closed, and the gas in the crank chamber 2A is compressed. As the piston 23 descends further, the exhaust valve 32 driven by the valve actuation mechanism 34 opens the exhaust port 31. This causes the expanded exhaust gas (combusted gas) in the combustion chamber 29 to flow into the exhaust port 31 as a blow-down flow.

Thereafter, as the piston 23 descends further to a point where the front edge of the piston 23 falls below the upper edge of the scavenging ports 50A (as the piston 23 opens the scavenging passage 50), the combustion chamber 29 and the scavenging passage 50 come to be communicated with each other. When the pressure of the combustion gas in the combustion chamber 29 is sufficiently reduced or to a level lower than the pressure in the crank chamber 2A, the gas flows from the scavenging passage 50 into the combustion chamber 29. At this time, the fuel injection valve 54 injects fuel into the gas flowing through the scavenging passage 50.

When the piston 23 moves upward once again, the scavenging passage 50 is closed by the piston 23. Thereafter, as the piston 23 further rises, the exhaust valve 32 closes the exhaust port 31 so that the mixture in the combustion chamber 29 is compressed with the progress in the upward movement of the piston 23. At the same time, the pressure in the crank chamber 2A decreases to such an extent that the intake valve 48 is opened to draw fresh air into the crank chamber 2A from the intake port 43.

Thus, the engine E performs the two-cycle operation. The flow of the scavenging gas and the exhaust gas flowing from the scavenging passage 50 to the exhaust port 31 via the cylinder 22 forms a uniflow involving very little bending.

In this engine E, combustion of fuel is caused by a spark plug ignition at the startup, but, once the engine E is warmed up, combustion of fuel is caused by self-ignition. As the engine E continues to operate, the temperature of the engine main body 1 may rise to such a high level so that the ignition timing may be advanced. Therefore, the engine E is provided with a cooling device 60 for cooling the engine main body 1 when the temperature of the engine main body 1 has risen to a certain level. The cooling device 60 is described in detail in the following.

The cylinder block 3 and the cylinder head 4 is internally formed with a water jacket 61 consisting of a hollow space surrounding the combustion chamber 29 for circulating the coolant W. Further, the cylinder block 3 and the cylinder head 4 are integrally formed with a plurality of fins 3A and 4A projecting from the outer surface thereof.

The water jacket 61 communicates with the radiator 64 via coolant piping 62 and steam piping 63. The coolant W may consist of LLC (long life coolant) as long as it is applicable to boiling cooling, and circulates the water jacket 61 and the radiator 64 via the coolant piping 62 and the steam piping 63. The parts of the coolant piping 62 and the steam piping 63 extending between the engine main body 1 and the radiator 64 may consist of hoses.

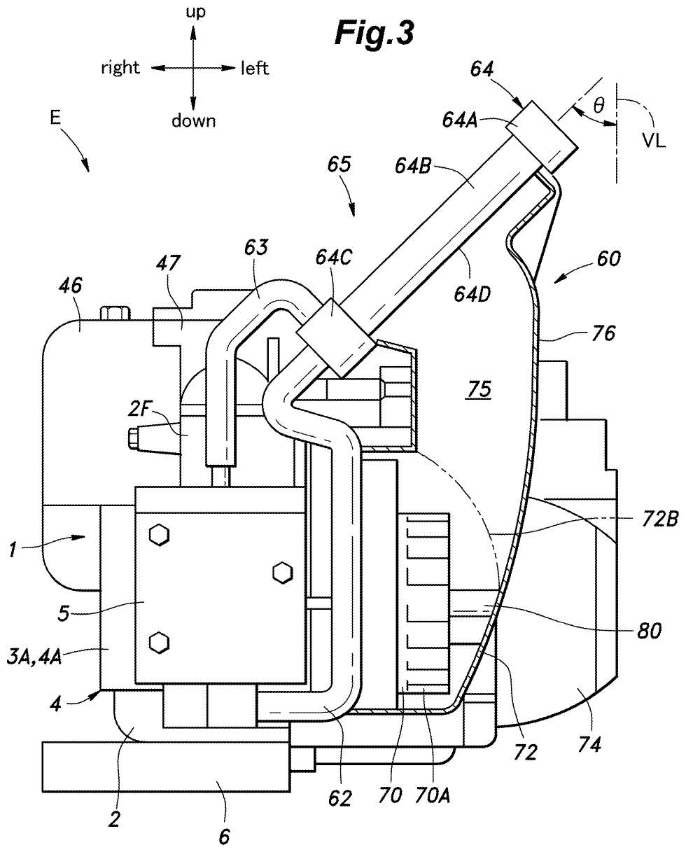

As shown in FIG. 3 also, the radiator 64 is integrally incorporated with an upper tank 64A, a radiator core 64B, and a lower tank 64C in that order from the upper side, and may consist of a per se known structure in which the upper tank 64A and the lower tank 64C communicates with each other via the radiator core 64B serving as a heat emitting part. The radiator 64 is disposed in such a manner that the upper tank 64A leans leftward, and a lower end of the lower tank 64C is located higher than the upper end of the water jacket and the upper surface of the cylinder block 3. The radiator 64 is inclined at an angle θ with respect to the vertical line VL with the left surface 64D thereof facing downward. The angle θ is greater than 0 degrees, preferably in the range of up to 60 degrees, and more preferably in the range of 30 to 60 degrees, the upright angle being defined as 0 degrees.

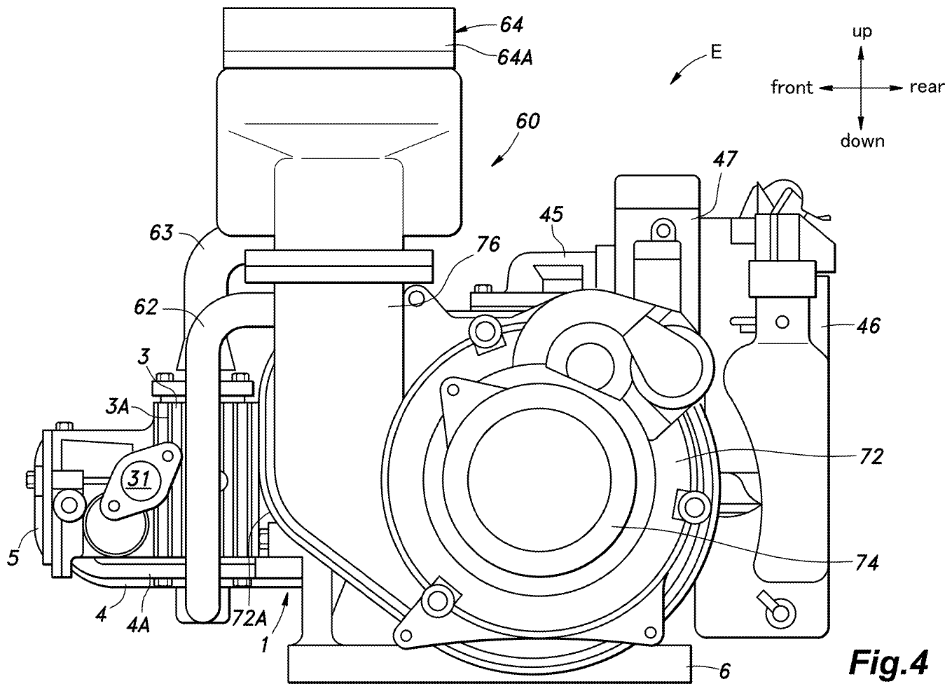

As shown in FIGS. 3 and 4, the coolant piping 62 is connected to the bottom surface of the lower tank 64C and the lower surface of the cylinder block 3 so that the lower tank 64C and the lower part of the water jacket 61 communicate with each other. The steam piping 63 is connected to the side surface of the lower tank 64C that faces obliquely upward and the upper surface of the cylinder block 3 so that the upper part of the lower tank 64C and the upper part of the water jacket 61 communicate with each other.

As shown in FIG. 5, the coolant W in the water jacket 61 boils on the wall surface of the water jacket 61 on the side of the combustion chamber 29 when the combustion chamber 29 is at a high temperature, and the latent heat associated with the boiling causes more heat to be removed from the surrounding wall of the combustion chamber 29 than in a water cooling system where no boiling takes place.

Therefore, the engine main body 1 is cooled with a high thermal efficiency. The steam S generated by boiling flows into the lower tank 64C of the radiator 64 via the steam piping 63.

The lower tank 64C receives the steam S from the steam piping 63 and the coolant W at high temperature in a mixed state. The high temperature coolant W is mixed with the coolant W stored in the lower tank 64C, and only the steam S enters the radiator core 64B from the lower tank 64C. The steam S entering the radiator core 64B ascends the radiator core 64B as shown by the broken line arrow, and is condensed by being cooled in the radiator core 64B. The droplets Wd of the coolant W condensed in the radiator core 64B flow down inside the radiator core 64B as shown by the solid line arrows, and are stored as the coolant W in the lower tank 64C.

Since the interior of the radiator core 64B is distinctly separated into a part which is cooled by the circulation of the steam S and a part in which the liquid droplets Wd flow down, there is no need to connect the steam piping 63 to the upper tank 64A to cause the steam S and the droplets to flow in the same direction.

The amount of the coolant W is set such that the liquid level Wa in the radiator 64 is higher than the upper end of the water jacket 61, and in a middle part of the lower tank 64C when the steam S is generated. Due to the generation of the steam S, the liquid level Wa in the radiator 64 is higher than the liquid level Wb of the coolant W in the steam piping 63 as indicated by h in FIG. 5. Therefore, the coolant W in the radiator 64 flows toward the water jacket 61 so that the coolant W naturally circulates through the radiator 64 and the water jacket 61 even though a water pump is absent.

The water jacket 61, the coolant piping 62, the steam piping 63, and the radiator 64 thus form a boiling cooling device 65. According to this boiling cooling device 65, the coolant W can be naturally circulated to the radiator 64 and the water jacket 61 without requiring a water pump. Further, since the coolant W returned to the radiator 64 together with the steam S is separated from the steam S in the lower tank 64C, and only the steam S enters the radiator core 64B, there is no need to provide a gas liquid separator. As described above, since the need for the water pump and the gas liquid separator is eliminated, the boiling cooling device 65 requires a smaller number of component parts, and can be reduced in size as compared to the conventional boiling cooling device provided with such devices. Since the steam S can be condensed by the radiator core 64B which accounts for a large part of the radiator 64, the efficiency in condensing the steam S can be improved.

In particular, when applied to a CAI combustion engine using a controlled auto-ignition (CAI) combustion process which requires the coolant to be raised in temperature to an appropriate level as quickly as possible following the startup, the boiling cooling device 65 allows this to happen in a favorable manner. As a result, the time period required for the temperature of the coolant W to stabilize at the time of cold start is minimized so that the problem of an unstable combustion that can otherwise occur before the warm up of the engine is completed can be avoided.

Further, since the temperature of the coolant W is substantially equal to the boiling point of the coolant W, the fluctuations in the coolant temperature can be minimized as compared to the case where the temperature of the coolant is controlled by a temperature control device such as a thermostat so that the combustion process can be stabilized.

As shown in FIG. 2, an air cooling fan 70 is attached to the left end of the crankshaft 8 that protrudes from the crankcase 2. The air cooling fan 70 is formed as a hollow cylinder having a disk plate at a bottom thereof, and serves also as a flywheel. To the engine main body 1 is fastened a cover member 72 that covers the air cooling fan 70 from the left side. A plurality of vanes 70A are attached to the left side of the disk plate of the air cooling fan 70, and are arranged along the circumferential direction at a regular interval. Each vane 70 is slanted relative to the radial direction so that the outer edge of the vane recedes with respect to the rotational direction of the air cooling fan 70. The radially inner part of the disk plate is formed with a plurality of vent holes 70B. The air cooling fan 70 rotates integrally with the crankshaft 8, and forms a centrifugal fan that blows air drawn from the right side of the rotating part thereof through the vent holes 70B radially outward with the vanes 70A.

The cover member 72 is arranged such that the front edge thereof is spaced from the outer surface of the cylinder block 3, and the remaining peripheral edge thereof is not spaced from the outer surface of the crankcase 2 and the cylinder block 3. In other words, the cover member 72 defines a cooling air inlet 72A that is located on the front and right side of the air cooling fan 70 to allow external air to be drawn toward the cylinder block 3 and the fins 3A and 4A of the cylinder head 4. Further, as shown in FIG. 3 also, the cover member 72 defines a cooling air outlet 72B for discharging the air that is blown radially outward by the air cooling fan 70 in a front and upper side of the air cooling fan 70 so as to face upward.

During the operation of the engine E, the air cooling fan 70 rotates, whereby air is drawn into the cover member 72 from the cooling air inlet 72A, and as shown by a white arrow in FIG. 2, is discharged rearward and upward from the cooling air outlet 72B. At this time, the air drawn into the cooling air inlet 72A flows around the cylinder block 3 and the cylinder head 4 to receive heat from the fins 3A and 4A to cool the cylinder block 3 and the cylinder head 4.

The left end of the crankshaft 8 extends leftward through and beyond the cover member 72, and is connected to the rotor of an AC generator 74 disposed on the left side of the air cooling fan 70. The stator of the AC generator 74 is attached rotationally fast to the cover member 72. The rotation of the crankshaft 8 causes the rotor to rotate with respect to the stator so that electric power is generated by the AC generator 74.

As shown in FIGS. 3 and 4, the cover member 72 is integrally provided with a duct 76 defining a cooling air passage 75 (FIG. 3) that extends upward from the cooling air outlet 72B. The duct 76 extends tangentially from the air cooling fan 70 forming a centrifugal fan, and reaches the radiator 64. The cooling air passage 75 extends from the cooling air outlet 72B toward the left surface 64D of the radiator 64 which is a downwardly facing inclined surface of the radiator core 64B, and directs the cooling air discharged from the cooling air outlet 72B to the radiator core 64B.

As a result, the radiator 64 is cooled by forced air cooling so that the radiator 64 is enabled to exhibit a higher cooling efficiency than a naturally cooled radiator.

As shown in FIG. 5, the muffler 52A is provided on an upper right side of the radiator core 64B so that the muffler 52A is also cooled by the air that flows along the outer surface of the muffler 52A after going through a heat exchange in the radiator core 64B.

As described above, in the engine E according to the present embodiment, the cooling device 69 for cooling the coolant circulating in the water jacket 61 which is formed on the engine main body 1 is provided with, in addition to the boiling cooling device 65, the air cooling fan 70 connected to the left end of the crankshaft 8 protruding from the outer surface of the engine main body 1, and the cover member 72 (FIGS. 3 and 4) provided on the engine main body 1 so as to cover the air cooling fan 70 and define the cooling air passage 75 extending toward the radiator core 64B as shown in FIG. 2.

Owing to such an arrangement, the following effect can be achieved. Since the air cooling fan 70 is driven by the crankshaft 8, no electric motor is required.

Further, the cover member 72 forms the cooling air passage 75 extending toward the radiator core 64B, and the radiator core 64B receives air flow created by the air cooling fan 70 so that the heat exchange efficiency of the radiator 64 can be improved, and the necessary size of the radiator 64 can be minimized. Furthermore, the cooling device 60 uses both air cooling by the air cooling fan 70 and the boiling cooling using the radiator 64 cooled by forced air, and this contributes to the further reduction in the size of the radiator 64.

The cooling air passage 75 may also be configured to communicate the cooling air inlet 72A with the radiator core 64B. In this case, the air flow is reversed to that in the above embodiment in that the air cooling fan 70 draws the air that has passed through the radiator core 64B, and forwards the air toward the engine main body 1, but similar advantages can be obtained.

As shown in FIGS. 2 to 4, the air cooling fan 70 consisted of a centrifugal fan, and the cover member 72 included the duct 76 extending tangentially from the centrifugal fan to the radiator 64 in the foregoing embodiment. Since the duct 76 is disposed on the outer periphery of the cover member 72, the size of the engine E as measured in the direction of the rotational axis of the crankshaft 8 is prevented from increasing.

Further, as shown in FIG. 1 and FIG. 2, the engine main body 1 is configured such that that the rotational axis of the crankshaft 8 extends laterally (leftward and rightward), and the cylinder axis A extends generally in the fore and aft direction. The radiator 64 is disposed such that the upper end of the radiator leans toward the left or to the side on which the air cooling fan 70 is attached to the crankshaft 8, and the lower end of the radiator 64 is located higher than the upper end of the water jacket 61 as shown in FIGS. 1 and 3. Therefore, the size of the engine E as measured in the vertical direction can be minimized.

The duct 76 extends toward the left surface 64D of the radiator core 64B which is a downwardly facing sloped surface of the radiator core 64B. Therefore, the duct 76 can extend linearly and can be short in length so that the size of the engine E can be minimized.

Further, the steam piping 63 is in communication with the lower part of the radiator 64 so that the length of the steam piping 63 can be minimized, and the size of the engine E can be minimized.

In addition, as shown in FIG. 1, the multiple fins 3A and 4A are formed on the outer surface of the engine main body 1, and the cooling air inlet 72A is formed on the side of the fins 3A and 4A of the cover member 72 so that the engine main body 1 is efficiently cooled by the air cooling fan 70. As a result, even when the radiator 64 is reduced in size, the required cooling performance can be ensured.

The present invention has been described in terms of a specific embodiment, but the present invention is not limited by such an embodiment, and can be modified in various ways without departing from the spirit of the present invention as can be appreciated by a person skilled in the art. Also, the various components of the illustrated embodiment are not entirely essential for the present invention, and can be substituted and omitted without departing from the spirit of the present invention. For instance, the upper tank 64A may be omitted. In this case, for example, the radiator core 64B may be formed of a per se known fin and tube structure with the upper end of the tube closed. In this case also, the steam S which has risen in the tube is cooled in the upper part of the radiator core 64B, and the coolant W liquefied by the cooling can drip downward in the tube.

GLOSSARY OF TERMS

| | |
|---|---|
| 1: engine main body | 3A: fin |
| 4A: fin | 8: crankshaft |
| 60: cooling device | 61: water jacket |
| 62: coolant piping | 63: steam piping |
| 64: radiator | 64A: upper tank |
| 64B: radiator core (heat emitting part) | 64C: lower tank |
| 64D: left surface (downwardly facing | |
| sloped surface) | |
| 65: boiling cooling device | 70: air cooling fan |
| 72: cover member | 72A: cooling air inlet |
| 75: cooling air passage | 76: duct |
| A: cylinder axis | E: engine |
| W: coolant | |

1. An internal combustion engine comprising an engine main body defining a water jacket therein, and a cooling device for cooling a coolant in the water jacket,
the cooling device comprising:
a radiator provided such that a large part of the radiator is located above an upper end of the water jacket;
steam piping communicating an upper part of the water jacket with the radiator to forward the coolant that has boiled in the water jacket to the radiator;
coolant piping communicating a lower part of the radiator with a lower part of the water jacket to forward the coolant that has been cooled in the radiator to the water jacket;
an air cooling fan connected to one end of a crankshaft projecting from an outer surface of the engine main body; and
a cover member provided on the engine main body so as to cover the air cooling fan, and define a cooling air passage extending to a heat emitting part of the radiator,
wherein an outer surface of the engine main body is provided with a plurality of fins, and the cover member defines a cooling air inlet on a side of the fins.

2. The internal combustion engine according to claim 1, wherein the air cooling fan is a centrifugal fan, and the cover member includes a duct extending from the centrifugal fan in a tangential direction to the radiator.

3. The internal combustion engine according to claim 1, wherein the engine main body is disposed such that a rotational axis of the crankshaft extends laterally and a cylinder axial line extends in a substantially fore and aft direction, and
the radiator is disposed such that the upper end thereof leans toward a side of the one end of the crankshaft, and a lower end of the radiator is located higher than the upper end of the water jacket.

4. The internal combustion engine according to claim 1, wherein the air cooling fan is a centrifugal fan,
the cover member includes a duct extending from the centrifugal fan in a tangential direction to the radiator,
the radiator is disposed such that the upper end thereof leans, and
the duct extends toward a downwardly facing sloped surface of the heat emitting part of the radiator.

5. The internal combustion engine according to claim 1, wherein the steam piping communicates with a lower part of the radiator.

6. (canceled)
